(19) United States
(12) Patent Application Publication
(10) Pub. No.: US 2015/0275779 A1
(43) Pub. Date: Oct. 1, 2015

(54) METHOD FOR OPERATING AN INTERNAL COMBUSTION ENGINE

(71) Applicant: Robert Bosch GmbH, Stuttgart (DE)

(72) Inventors: Martin FROEHLICH, Linkenheim-Hochstetten (DE); Alexander Carsten ULRICH, Tamm (DE); Stefan GOTTLIEB, Hemmingen (DE)

(21) Appl. No.: 14/668,458

(22) Filed: Mar. 25, 2015

(30) Foreign Application Priority Data
Mar. 31, 2014 (DE) 10 2014 206 025.7

(51) Int. Cl. F02D 17/02; F01L 13/00

(52) U.S. Cl. CPC F02D 17/02; F01L 13/0005; F01L 2013/001

(57) ABSTRACT

For operating an internal combustion engine that includes at least one cylinder for which the engine includes a respective intake valve and valve mechanism, a method includes checking, for a particular one of the cylinders for which the respective valve mechanism is able to be deactivated, whether the particular cylinder will be suppressed according to a suppression pattern, and, if so, deactivating the valve mechanism.

### FIELD OF THE INVENTION

The present invention relates to a method for deactivating at least one intake valve of at least one cylinder during an operation of an internal combustion engine. In addition, the present invention relates to an internal combustion engine including at least one intake valve that can be deactivated, as well as to a charge control system for regulating a reduced consumption of the internal combustion engine caused by a deactivation of at least one intake valve of an internal combustion engine.

### BACKGROUND

As a rule, internal combustion engines include multiple cylinders which include individual combustion chambers that are opened or closed by valves in order to allow a gas exchange required for the combustion process. An internal combustion engine makes it possible to convert thermal energy from a combustion into kinetic energy, such as for driving a vehicle.

In particular, in the case of internal combustion engines including a plurality of cylinders, a so-called cylinder suppression is frequently used in order to influence combustion characteristics of a particular internal combustion engine, such as the fuel consumption or running smoothness, for example. To do so, particular cylinders are temporarily suppressed, i.e., not supplied with fuel, so that no combustion takes place in the suppressed cylinder.

By selective suppression of cylinders, internal combustion engines can be optimized with regard to a smoother gas acceptance or reduced reactions to load changes, as well as with regard to reduced consumption. However, because a cylinder suppression is always tied to a gas exchange cycle, cold ambient air enters an exhaust tract of the affected internal combustion engine through a deactivated cylinder during a so-called zero lift, which means that different components may sustain damage, especially an exhaust catalyst included in the exhaust tract, for instance by an exothermic reaction that is taking place under contact of the uncombusted fuel with fresh air.

The printed publication DE 10 2004 021 183 B1 describes a method in which an internal combustion engine is regulated by controlling an air supply as a function of an applied torque of the internal combustion engine, such that a switchover between part load and full load operation of the internal combustion engine takes place in a torque-neutral manner.

A method for operating an internal combustion engine including an exhaust-gas turbocharger is described in the printed publication DE 10 2011 119 528 A1, which provides for temporarily switching off, i.e., suppressing, particular cylinders as a function of a current rotational speed of the exhaust-gas turbocharger.

To regulate an output torque of an internal combustion engine, the printed publication DE 101 48 347 A1 describes a method in which particular cylinders of an internal combustion engine are throttled or shut off. To do so, intake and outlet valves of an individual cylinder of the internal combustion engine are controlled as a function of a throttling state, so that a jerky torque output is avoided.

The printed publication DE 100 55 595 A1 describes a method, in which particular cylinders of an internal combustion engine are activated or deactivated in alternation, so that the individual cylinders retain their operational temperature. To do so, both first and second cams are provided, which are allocated to an activated or deactivated state in order to control the particular cylinder appropriately.

### SUMMARY

According to an example embodiment of the present invention, a provides for suppression of at least one cylinder of an internal combustion engine in accordance with a suppression pattern to be specified, so that the at least one suppressed cylinder aspirates neither fresh cold ambient air nor fuel, with the result that potential damage to components of the internal combustion engine is avoided or at least reduced.

Traditionally, the blocking of a cylinder is a process in which an individual cylinder is not supplied with fuel, so that the affected cylinder does not contribute any output during the suppression process. However, because particular gas exchange valves are opened in such a suppression process, cold ambient air makes its way into the exhaust tract of the internal combustion engine, so that exothermic reactions with previously introduced uncombusted fuel may occur and consequently, damage to the catalyst and material fatigue of the exhaust tract or other components.

In order to avoid material fatigue by, for instance, the supply of fuel into the exhaust tract prior to a suppression process, e.g., by a mixture enrichment for reasons of component protection, and also in order to reduce the fuel consumption of the affected internal combustion engine, it is provided to deactivate, i.e., close, the intake valves of a suppressed cylinder. By deactivating the intake valves of a suppressed cylinder, no new gas or no new fuel is able to make its way into a combustion chamber of the affected cylinder during a cylinder suppression, so that the described consequences for the exhaust tract of the internal combustion engine are avoided.

When the intake valves of a particular cylinder are deactivated, a combustion space or a combustion chamber of the individual cylinder remains empty during a gas exchange cycle, during which exhaust gases are expelled and mixture is aspirated as a general rule, which means that a piston moving within the individual cylinder is pumping neither fuel nor cold ambient air into the exhaust tract. It is conceivable that the vacuum pressure created by the movement of the piston aspirates already heated gases from the exhaust tract and/or from a crankshaft housing, but no damage to components of the individual internal combustion engine is to be expected as a result and an active component protection is not at risk or interrupted.

In an example embodiment, the involved outlet valves, i.e., valves of a suppressed cylinder, are likewise deactivated as a function of a particular suppression pattern. By shutting down particular outlet valves, pressure fluctuations in the exhaust tract, which could lead to undesirable noise, are avoidable.

The deactivation of the intake valves and/or outlet valves of a particular cylinder also causes savings in fuel because the friction in the valve control is reduced. In addition, the deactivation of the intake valves and/or outlet valves causes a reduction in the particular charge cycle losses, which contribute to the fuel consumption due to resistance of individual components of an intake tract and which are likewise no longer relevant in a deactivation of the particular valves.

Another advantage of a deactivation of intake valves according to the introduced method is that an active component protection is able to maintained, since the method of the present invention allows a rich operation of the affected internal combustion engine even during an active suppression.

The deactivation of the intake or outlet valves of an individual cylinder can take place via an intervention in a particular valve mechanism, for example, by which the intake and/or outlet valves are deflected, i.e., opened or closed, a valve mechanism being able to be controlled mechanically, electromechanically, hydraulically or pneumatically.

In an example embodiment, a particular valve mechanism or a particular valve lift system is deactivated for controlling intake or outlet valves of a suppressed cylinder, using a control unit, which transmits control commands to the valve mechanism. The control unit can be realized externally or it can be integrated into a particular engine control unit of the internal combustion engine in question. By way of commands for deactivating and/or suppressing particular elements of the valve mechanism, a control unit of a vehicle that includes an internal combustion engine is able to deactivate intake and/or outlet valves in a selective manner.

Furthermore, using a control unit, it is possible to carry out calculations in connection with a suppression pattern, for instance, whereby individual intake and/or outlet valves are already able to be deactivated or reactivated at an early stage. Since a suppression of cylinders, i.e., blocking of a scheduled fuel introduction into the affected cylinder, is usually carried out as a function of a driving behavior of a driver of the vehicle in question, an individual suppression pattern usually requires calculations, based on which a power output desired by the driver is achieved. In order to react rapidly and efficiently to possibly occurring changes in the suppression pattern, affected intake valves must likewise be deactivated or activated in a rapid and efficient manner. Such a rapid and efficient control, i.e., deactivation and activation or reaction, is possible when using a control unit.

In the context of the present invention, a suppression pattern means a series of suppressions, i.e., injection processes of individual cylinders of an internal combustion engine that are not carried out, for example. This sequence can repeat cyclically. Suppression patterns are frequently used for a brief torque reduction such as in an ESP or transmission intervention, for example. In addition, suppression patterns can be fixedly predefined or be variably adapted to a particular driving or operating situation.

It is provided that during an active cylinder suppression for a particular cylinder that is next, for which the valve lift or valve mechanism can be deactivated, it is checked whether the next cylinder will be suppressed in accordance with a current suppression pattern. If the next cylinder will be suppressed, then the valve lift or valve mechanism of the particular intake and/or outlet valve or the intake and/or outlet valves of a cylinder that is next is/are deactivated. As soon as the suppression has ended, the valve lift or valve mechanism is reactivated. In particular, when using variable valve mechanisms or valve lift systems, it is possible for a particular valve mechanism or valve lift to be deactivated by reducing a corresponding valve lift travel to zero.

In an example embodiment, during a particular deactivation of an intake and/or outlet valve of a suppressed cylinder, a possibly occurring higher charge, e.g., caused by an increased manifold pressure on account of the particular current suppression or valve deactivation, is compensated for in non-suppressed cylinders. For example, such a compensation of a particular fuel supply can be achieved by adapting a particular fuel control system or charge control system, for example using a modified valve opening curve or throttling via a single-throttle system, for example.

In addition, the present invention relates to a control unit for controlling or regulating an individual deactivation of input and/or output valves of an individual cylinder of a particular internal combustion engine.

A control unit included by an internal combustion engine, or any other additional technically suitable control unit, can be configured as for controlling an individual deactivation or activation of valves or valve mechanisms of inlet and/or outlet valves.

If a fixed suppression pattern is used for an operation of an internal combustion engine, it is provided that this suppression pattern is stored in a control unit for controlling the deactivation or activation of particular intake and/or outlet valves or valve mechanisms, so that the suppression pattern is accessible to the method of the present invention.

In addition, according to an example embodiment, the present invention relates to an internal combustion engine including at least one cylinder, with at least one intake valve and at least one outlet valve, where the at least one intake valve and/or the at least one outlet valve are/is to be deactivated or activated as a function of a suppression pattern.

The introduced internal combustion engine is primarily characterized by greater component protection, by reduced loading of the catalyst and by reduced consumption in comparison with conventional internal combustion engines without selective deactivation of intake and/or outlet valves during an active cylinder suppression.

Furthermore, the present invention relates to a charge control system, which compensates, i.e., balances, a charge excess that may arise in a selective intake or outlet valve deactivation.

Toward this end, in an example embodiment, the charge control system, for example, includes a single throttling system or a device for adapting a particular valve opening curve, so that an optimum supply of mixture to non-suppressed cylinders is possible also when one or more further cylinder(s) is/are suppressed.

The described fuel control system, for instance, can be developed as a system of injection valves or any other technically suitable device for metering or introducing fuel into a combustion chamber or a combustion space of a cylinder.

The present invention is represented in the drawings on the basis of specific embodiments and described in detail in the following text with reference to the drawings. Additional advantages and further developments of the present invention derive from the detailed description and the appended figures. The aforementioned features and the features described below can be used not only in the individually given combination but in other combinations or in isolation as well, without departing from the scope of the present invention.

### BRIEF DESCRIPTION OF THE DRAWINGS

FIG. 1 is a flowchart that illustrates a method, according to an example embodiment of the present invention.

FIG. 2 shows a schematic illustration of a cylinder of an internal combustion engine, in a non-suppressed state, according to an example embodiment of the present invention.

FIG. 3 shows a schematic illustration of the cylinder from FIG. 2, in a suppressed state, according to an example embodiment of the present invention.

### DETAILED DESCRIPTION

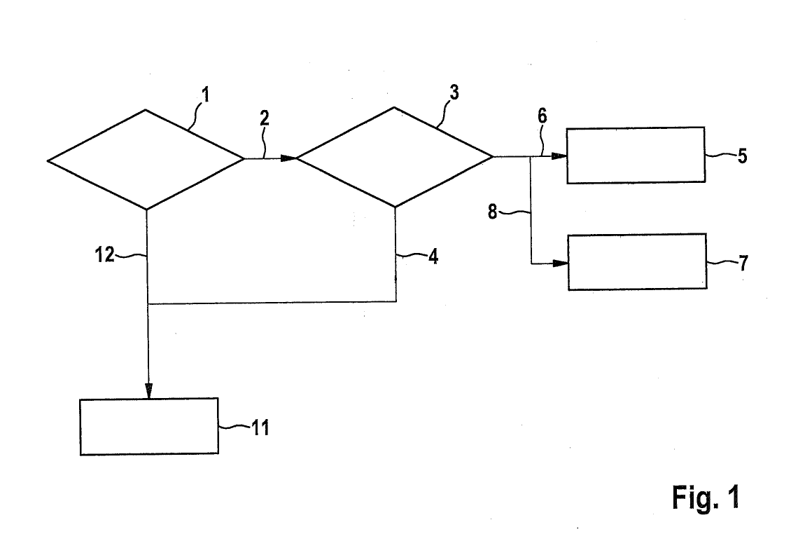

In the method shown in FIG. 1 for operating an internal combustion engine, it is checked in a first check step 1 whether a cylinder suppression is currently active in the operation of the internal combustion engine. If a cylinder suppression is presently active, it is checked in a further check step 3, as indicated by arrow 2, for a particular following cylinder for which a valve lift of individual intake valves can be switched off, whether the particular cylinder is currently included in a suppression pattern stored in a control unit. If the particular cylinder is currently included in the suppression pattern, an individual intake and/or outlet valve lift or valve mechanism is set to a zero lift in an actuating step 5, as indicated by arrow 6, which means that the intake valve is closed. Furthermore, as indicated by arrow 8, a quantity of fuel supplied to the internal combustion engine is compensated in a control step 7 in such a way that the fuel quantity to be supplied to the suppressed cylinder in a normal operation is held back, i.e., a particular fuel control system is supplied with fuel that is reduced by this amount.

In the event that no cylinder suppression is currently active in the internal combustion engine, then it is provided, as indicated by arrow 12, to switch directly to an actuation step 11, in which the individual settings for zero lift, i.e., individual valve suppressions, are deactivated. The same applies in the event that an individual cylinder is currently not included in a particular suppression pattern, as indicated by arrow 4. A deactivation of zero lift settings is meant to avoid missing charges of individual cylinders in the event that no cylinder suppression is expected.

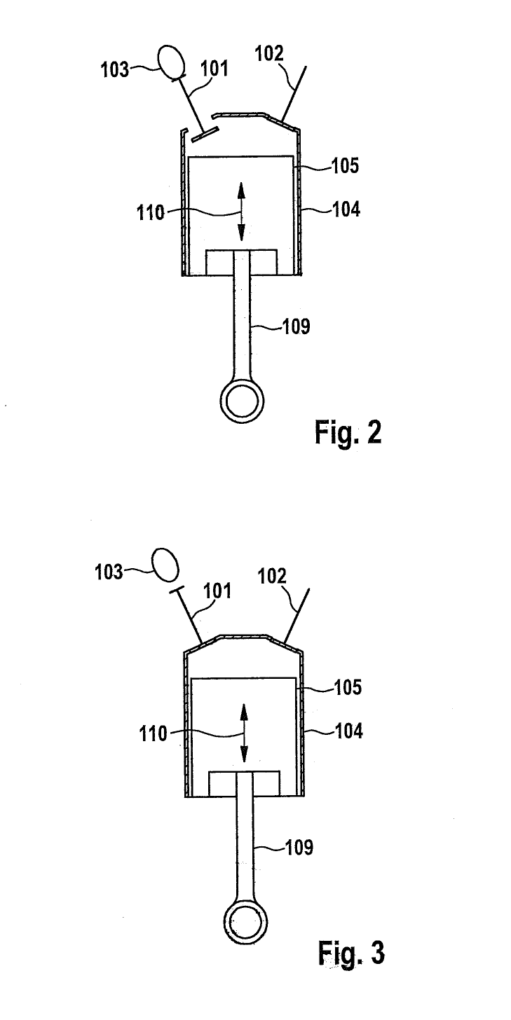

In the situation depicted in FIG. 2, cylinder 104, shown in FIG. 2 and for which there is an intake valve 101 and an outlet valve 102, is in an intake stroke, in which fuel is aspirated through open intake valve 101. In the process, a valve mechanism 103 presses intake valve 101 into cylinder 104 in such a way that cylinder 104 is opened and fuel is able to enter and be ignited, piston 105 as well as piston rod 109 being induced to execute a lifting movement, as indicated by arrow 110.

FIG. 3 shows cylinder 104 in a suppressed situation, i.e., cylinder 104 is likewise in an intake stroke, and valve mechanism 103 has previously been brought into a deactivated position, so that valve mechanism 103 does not press intake valve 101 into cylinder 104 and the cylinder remains closed as a result. Accordingly, the lifting movement of piston 105, as indicated by arrow 110, does not lead to an introduction of fuel into cylinder 104, so that piston 105 as well as piston rod 109 are not supplied with additional energy either. Instead, piston 105 now oscillates in opposition to air resistance within sealed cylinder 104, which may possibly lead to a delay in the lifting movement of piston 104. Accordingly, piston 105 in cylinder 104 is oscillating without consuming fuel.

However, as soon as cylinder 104 is reactivated again, valve mechanism 103 drops, presses intake valve 101 into cylinder 104 and thereby allows fuel to enter cylinder 104 and the conversion of thermal energy or potential energy into kinetic energy by the internal combustion engine.

What is claimed is:

1. A method for operating an internal combustion engine that includes at least one cylinder for which the internal combustion engine includes a respective intake valve and a corresponding valve mechanism, the method comprising:
checking, by an internal combustion engine control machine and for a particular one of the at least one cylinder for which the respective valve mechanism is able to be switched off, whether the particular cylinder will be suppressed according to a suppression pattern to be applied; and
responsive to an affirmative determination in the checking step, deactivating, by the control machine, the respective valve mechanism of the particular cylinder.

2. The method of claim 1, further comprising:
subsequent to the deactivation, activating the valve mechanism when the suppression pattern provides that the particular cylinder is to be activated.

3. The method of claim 1, wherein the internal combustion engine is part of a vehicle.

4. The method of claim 1, further comprising:
compensating, by a fuel control system, for a fuel excess to be expected as a result of a deactivation of the valve mechanism.

5. The method of claim 1, wherein the at least one cylinder includes a plurality of cylinders between which application of the suppression pattern is shifted in accordance with a predefined pattern.

6. The method of claim 5, wherein the suppression pattern is shifted such that a fuel supply is calculated for a first suppressed cylinder in each case.

7. The method of claim 1, further comprising, responsive to the affirmative determination in the checking step, deactivating a valve mechanism of an outlet valve of the particular cylinder.

8. A control unit for a vehicle that includes an internal combustion engine, the internal combustion engine including at least one cylinder for which the internal combustion engine includes a respective intake valve, the control unit comprising:
a data storage in which a suppression pattern is stored; and
control circuitry, wherein the control circuitry is configured to deactivate and reactivate the intake valve of at least one of the at least one cylinder of the internal combustion engine as a function of the suppression pattern.

9. An internal combustion engine comprising:
at least one cylinder; and
for each of the at least one cylinder, a respective intake valve, wherein the internal combustion is configured for deactivation and reactivation of the respective intake valve as a function of a suppression pattern.

10. A charge control system for an internal combustion engine, the internal combustion engine including at least one cylinder and, for each of the at least one cylinder, a respective intake valve that is configured for deactivation and reactivation as a function of a suppression pattern, the charge control system comprising control circuitry configured to modify a fuel quantity supplied to the internal combustion engine as a function of the deactivation of the respective intake valve.
